(19) United States
(12) Patent Application Publication
(10) Pub. No.: US 2019/0351540 A1
(43) Pub. Date: Nov. 21, 2019

(54) CONTAINER ORGANIZERS

(71) Applicant: John Lamb, Winlock, WA (US)

(72) Inventor: John Lamb, Winlock, WA (US)

(21) Appl. No.: 16/447,305

(22) Filed: Jun. 20, 2019

(51) Int. Cl. B25H 3/02; F16M 13/02

(52) U.S. Cl. CPC B25H 3/023; F16M 13/022

(57) ABSTRACT

A method, system, apparatus, and/or device for storing and organizing objects in a container. The method, system, apparatus, and/or device may include an insert panel configured to hold an object. The insert panel may include a first clamp cavity including a first opening configured to receive a first clamp post of a modular attachment assembly and a second clamp cavity including a second opening configured to receive a second clamp post of the modular attachment assembly. The method, system, apparatus, and/or device may include the modular attachment assembly configured to hold the object against the insert panel. The modular attachment assembly may include the first clamp post, a second clamp post, and a cord having a first end connected to the first clamp post and a second end connected to the second clamp post.

### BACKGROUND

A toolbox or tool chest is a container to organize, early, and protect tools. The toolbox may be used as part of a trade, a hobby, or for do-it-yourself (DIY) projects. The tools inside the toolbox may vary based on the tools needed for the trade, the hobby, and/or the DIY project.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding.

FIG. 1 illustrates a container with inserts to organize and store objects according to an embodiment.

FIG. 2A illustrates a disassembled view of the insert, according to an embodiment.

FIG. 2B illustrates a side cross-sectional view of the insert, according to an embodiment.

FIG. 3 illustrates a zoomed-in view of a front portion of the insert with the clamp cavities, according to an embodiment.

FIG. 4A illustrates a cross-sectional view of a portion of the modular attachment assembly inserted into a clamp cavity, according to an embodiment.

FIG. 4B illustrates a front view of the clamp cavity with the clamp post inserted within, according to an embodiment.

FIG. 4C illustrates a cross-sectional view of a portion of the modular attachment assembly inserted into a clamp cavity and rotated the clamp tabs to lock the clamp post into place, according to an embodiment.

FIG. 4D illustrates a front view of the clamp cavity with the clamp post being rotated to lock the clamp post into place, according to an embodiment.

### DETAILED DESCRIPTION

The disclosed container organizers will become better understood through a review of the following detailed description in conjunction with the figures. The detailed description and figures provide merely examples of the various embodiments described herein. Those skilled in the art will understand that the disclosed examples may be varied, modified, and altered and not depart from the scope of the embodiments described herein. Many variations are contemplated for different applications and design considerations; however, for the sake of brevity, the contemplated variations may not be individually described in the following detailed description.

Throughout the following detailed description, examples of various container organizers are provided. Related features in the examples may be identical, similar, or dissimilar in different examples. For the sake of brevity, related features will not be redundantly explained in multiple examples. Instead, the use of related feature names will cue the reader that the feature with a related feature name may be similar to the related feature in an example explained previously. Features specific to a given example will be described in that particular example. The reader is to understand that a given feature need not be the same or similar to the specific portrayal of a related feature in any given figure or example.

Toolboxes or tool chests are containers to organize, carry, and protect tools. There are various tool chests available to service the needs of carpenters, mechanics, roofers, hobbyists, do-it-yourselfers (DIYers), and so forth. Conventional tool chests may include multiple drawers, trays, and/or open cavities for storing various tools. However, while the conventional drawers, trays, and/or open cavities provide a place for a user to store their tools, the drawers, trays, and/or open cavities of the tool chest tend to become unorganized as the user uses the tools and takes the tools in and out of the tool chest. For example, a user often finds that the tool they desire to use is located beneath several other tools, causing the user to have to unload several tools to get to the desired tool or to not see the desired tool and believe the tool has been misplaced. Looking for tools the user believes are lost or removing every tool or item in a tool chest can be very time consuming, inefficient, and frustrating. Additionally, unorganized tool chests may cause the user to carry around infrequently used tools or tools that they do not need because they remain unseen or covered up at a bottom of the tool chest, making the tool chest cumbersome and heavier than necessary.

Implementations of the disclosure address the above-mentioned deficiencies and other deficiencies by providing methods, systems, devices, or apparatuses to store and organize objects. The methods, systems, devices, or apparatuses may include a container (such as a toolbox or a tool chest) configured to store inserts with modular attachment assemblies to fasten the objects to the inserts. A modular attachment assembly may include a cord and posts that may, be configured to attach to the insert to fasten the objects against the insert to hold the objects in place. An advantage of the container and modular attachment assemblies may be to store multiple objects of various sizes and/or shapes in a variety of positions. Another advantage of the inserts may be to cleanly organize objects in the container. Another advantage of the inserts may be to provide removable object holders that a user may remove when the objects are not in use and may be temporarily removed for the user to view to find a desired object.

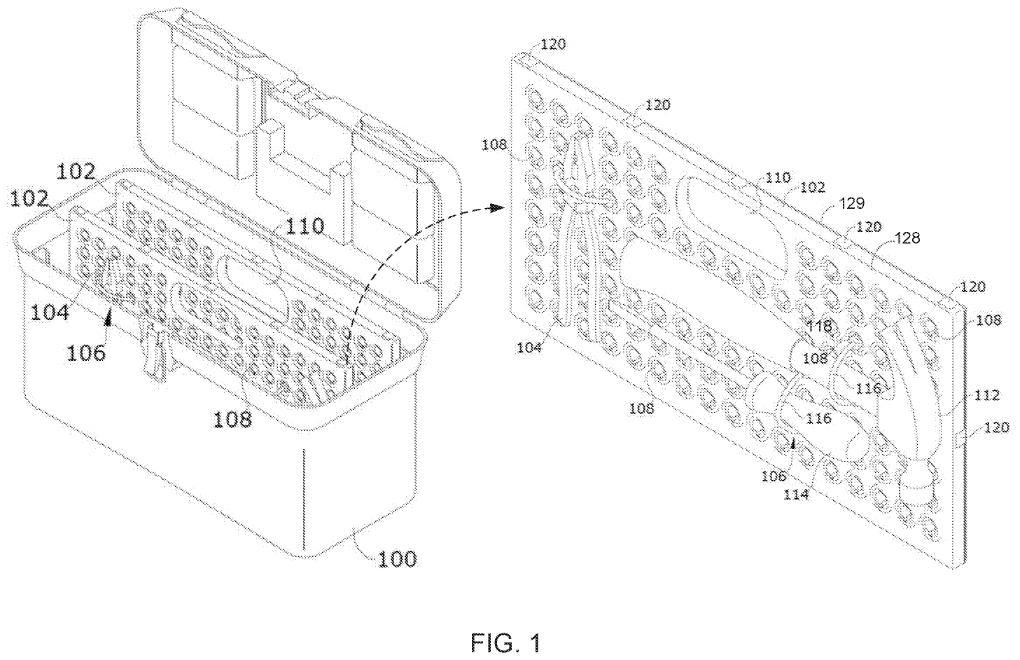

FIG. 1 illustrates a container 100 with insert panels 102 to organize and store objects 104, 112, and 114, according to an embodiment. In one embodiment, the container 100 may be a toolbox, a tool chest, a carton, a crate, a trunk, a case, a chest, a bin, and so forth. In one embodiment, the container 100 may include slots to receive and hold the insert panels 102. For example, a slot may be an elongated depression, a groove, a notch, a slit, and/or an aperture. In another example, each slot may be configured to receive an insert panel 102. In another example, the slots may be separated or have gaps between each slot to provide space for the objects 104, 112, and/or 114 between each insert panel 102 that is inserted or stored in the container 100. The objects 104 may be tools, devices, utensils, supplies, equipment, and so forth. In one example, an insert panel 102 may be configured to hold and store different types of objects such that a single insert panel 102 may hold hand tools, knitting material, and medical supplies at the same time. In another example, a user may attach different types of objects to different insert panels 102 that may be easily swapped out, such as carpeting tools for a first insert panel 102 and roofing tools for a second insert panel 102.

In another embodiment, the insert panel 102 may include a modular attachment assembly 106, clamp cavities 108, and a handle hole 110. The modular attachment assembly 106 may include a cord 116 and clamp posts 118. In one example, the cord 116 may be an elastic cord, a bungee cord, a rubber band, a nylon-cased band, a stretchable band, and so forth. The clamp posts 118 may be attached to each end of the cord 116. The length of the cord 116 may vary based on the size of the objects 104, 112, and/or 114, the spacing or pattern of the clamp cavities 108, the desired tension of the cord 116 to hold the objects 104, 112, and/or 114 to the insert panel 102, and so forth. In one example, the configuration of the clamp cavities 108 may be a rectangular or square grid pattern. In another example, the configuration of the clamp cavities 108 may be a honeycomb pattern.

In another embodiment, the modular attachment assembly 106 may be used to fasten or hold the object 104, 112, and/or 114 against the insert panel 102 in a relatively fixed position. For example, to fasten or hold the object 104, 112, and/or 114 to the insert panel 102, a first clamp post 118 attached to a first end of the cord 116 may be inserted into a first clamp cavity 108. The cord 116 may then be pulled to stretched across a portion of the object 104, 112, and/or 114 to partially circumscribe the object 104, 112, and/or 114. A second clamp post 118 attached to a second end of the cord 116 may be inserted into a second clamp cavity 108 so that the cord 116 is affixed against the object 104, 112, and/or 114. In this example, when the first and second clamp posts 118 are inserted into the first and second clamp cavities 108, the cord 116 may be stretched across an outer face of the object 104, 112, or 114 (i.e. a surface or face of the object facing away from the insert panel 102) such that an inner face of the object 104, 112, or 114 may be held against a surface of the insert panel 102 in a relatively fixed position.

The relatively fixed position may be where a movement of the object 104, 112, or 114 may be restricted or eliminated. In one example, the object 104, 112, or 114 may be fixedly held against the insert such that the object 104, 112, or 114 may not move until the first or second clamp posts 118 are removed or detached from the first or second clamp cavities 108, respectively. In another example, when the object 104, 112, or 114 is fastened or held against the insert panel 102, the object 104, 112, or 114 may move within a threshold range but remain fastened and held against the insert panel 102. In one embodiment, the clamp posts 118 of a modular attachment assembly 106 may be moved around independent of each other to accommodate different sizes of objects a user may desire to attach to the insert panel 102. For example, a user may insert a first clamp post 118 in a first clamp cavity 108 at a first location along the surface of the insert panel 102 and a second clamp post 118 in a second clamp cavity 108 at a second location along the surface of the insert panel 102 to accommodate a relatively, small object. In another example, a user may insert the first clamp post 118 in a third clamp cavity 108 at a third location along the surface of the insert panel 102 and a second clamp post 118 in a second clamp cavity 108 at a third location along the surface of the insert panel 102 to accommodate a relatively large object.

In one embodiment, the threshold range may be a coplanar movement of the object 104, 112, or 114 relative to a surface of the insert panel 102. In another embodiment, the threshold range may be perpendicular or at an angle relative to the surface of the insert panel 102 such that the object 104, 112, or 114 may rotate, twist, or turn while being held against the surface of the insert panel 102. In another embodiment, when the cord 116 is elastic, the cord 116 may stretch to allow the object 104, 112, or 114 to temporarily not be held against the insert panel 102 before contracting to hold the object 104, 112, or 114 against the insert panel 102, such as when the object 104, 112, or 114 is pulled, pushed, bumped, bounced, and so forth.

In another embodiment, the insert panel 102 may include a back plate 124 and a front plate 128 that is fastened or held together by tabs 120. In another embodiment, the insert panel 102 may include a handle hole 110 for an individual to grab and/or lift the insert panel 102 to place the insert panel 102 into the container 100, remove the insert panel 102 from the container 100, and/or to move the insert panel 102. In another embodiment, the insert panel 102 may include handle holes 110 along the top side, left side, right side, and/or the bottom side of the insert panel 102 such that the user may insert the insert panel 102 in the container 100 in different orientations.

In one embodiment, the insert panel 102 may be 212 millimeters (mm) in height, 439 mm in length, and 15 mm in thickness. In another embodiment, the handle hole 110 may be 102 mm in length. In another embodiment, a clamp cavity 108 may be 11 min in diameter. In another embodiment, a spacing between two clamp cavities 108 may be 25 mm between the centers of each clamp cavity 108. The sizes, dimensions, and configurations provided herein are not intended to be limiting and may vary based on the size and/or shape of the container 100.

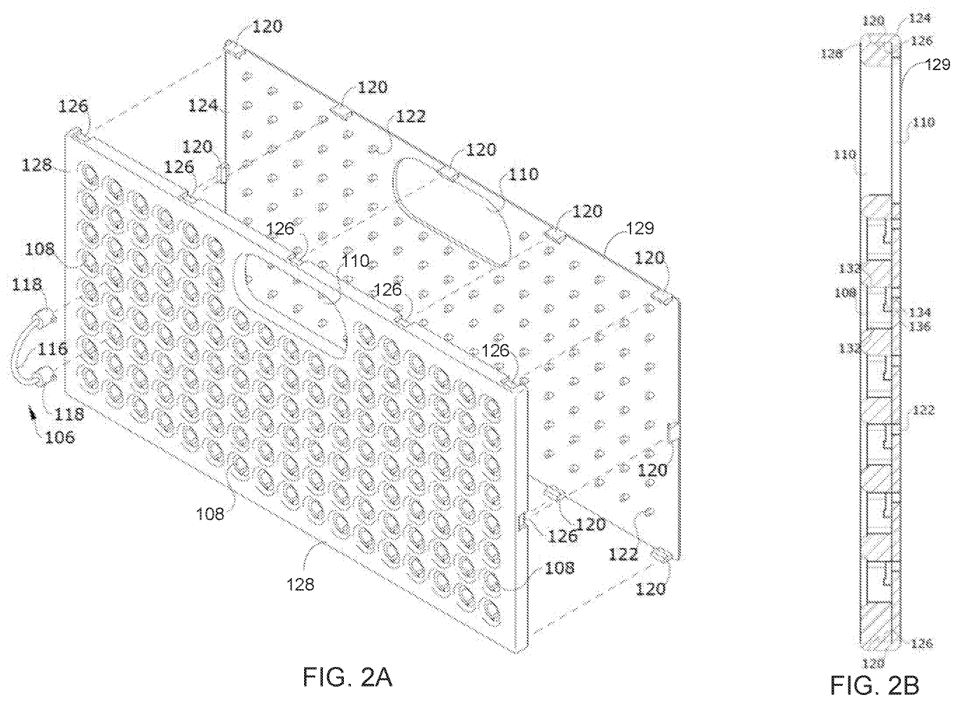

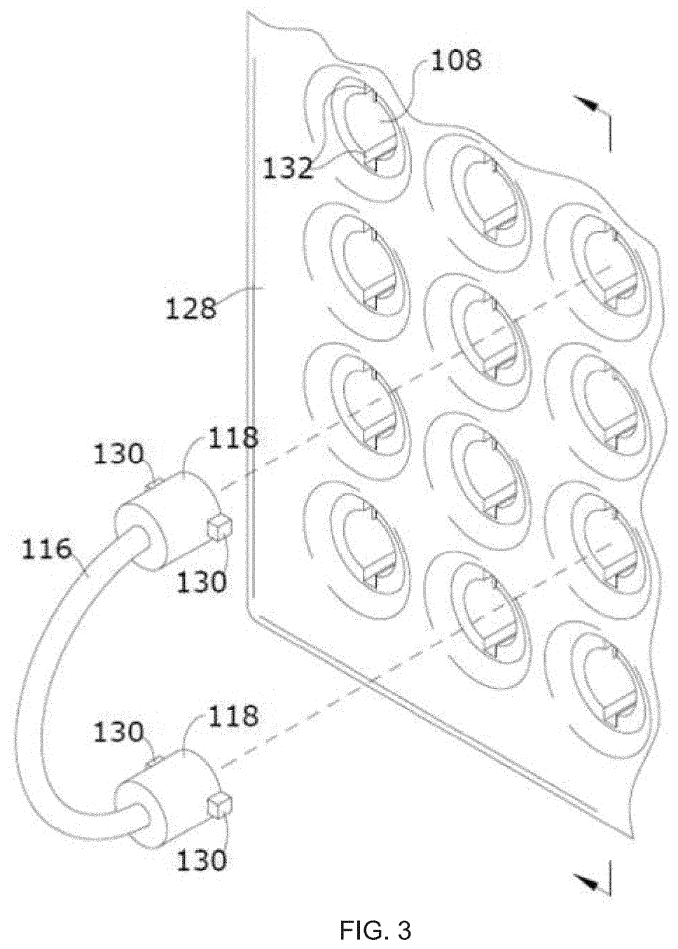

FIG. 2A illustrates a disassembled view of the insert panel 102, according to an embodiment. Some of the features in FIG. 2A are the same or similar to some of the features in FIG. 1 as noted by same reference numbers, unless expressly described otherwise. As discussed above, the insert panel 102 may include a back plate 124 and a front plate 128. In one embodiment, the front plate 128 may include clip slots 126 to receive the tabs 120 of the back plate 124. For example, the tabs 120 may be snapped into or interested into the clip slots 126 to fasten the front plate 128 to the back plate 124. In one embodiment, the tabs 120 may be 9 mm-10 mm in height and may vary in width. The sizes, dimensions, and configurations provided herein are not intended to be limiting and may vary based on the size and/or shape of the container 100. In another embodiment, the front plate 128 may be fastened to the back plate 124 with a variety of different fasteners, such as screws, bolts and nuts, epoxy, clips, rivets, hooks, and so forth.

In another embodiment, the back plate 124 may include drain holes 122. When the back plate 124 is connected to the front plate 128, the drain holes 122 may align with the clamp cavities 108 such that a channel is formed from a front surface of the front plate 128 to a back surface of the back plate 124. For example, when fluids and/or other material enter or are deposited into one or more of the clamp cavities 108, the drain holes 122 may provide a drain for the fluids and/or other materials to exit the clamp cavities 108 so that the fluids and/or the other material may not become trapped at a bottom of the clamp cavities 108. In another example, a diameter of the drain holes 122 may be smaller than a diameter of the clamp cavities 108 so that the clamp posts 118 may be inserted into the clamp cavities 108 while stopping the clamp posts 118 from extending to the back surface of the back plate 124.

FIG. 2B illustrates a side cross-sectional view of the insert panel 102, according to an embodiment. Some of the features in FIG. 2B are the same or similar to some of the features in FIGS. 1 and 2A as noted by same reference numbers, unless expressly described otherwise. As discussed above, the insert panel 102 may include a back plate 124 and a front plate 128 that may be fastened together. As further discussed above, the back plate 124 may include tabs 120 that may be inserted into the clip slots 126 to fasten the back plate 124 to the front plate 128. In one embodiment, when the back plate 124 and the front plate 128 are fastened together, they may form a cavity 134 with tab slots 132 to secure the clamp posts 118 in FIGS. 1 and 2A to the insert panel 102, as further discussed below. When the clamp posts 118 are inserted into the clamp cavities 108, the clamp posts 118 may include clamp tabs 130 (as shown in FIG. 3) that may be rotated to lock and/or unlock the clamp posts 118 to the insert panel 102 via the tab slots 132.

FIG. 3 illustrates a zoomed-in view of a front portion of the insert panel 102 with the clamp cavities 108, according to an embodiment. Some of the features in FIG. 3 are the same or similar to some of the features in FIGS. 1-2B as noted by same reference numbers, unless expressly described otherwise. As discussed above, the modular attachment assembly 106 may be attached to the insert panel 102 to fasten or hold an object against the insert panel 102. As further discussed above, the modular attachment assembly 106 may include the cord 116 and the clamp posts 118. The clamp posts 118 may include clamp tabs 130 that extend from the sides of the clamp posts 118. The clamp tabs 130 may be protrusions, flaps, knobs, and so forth. The clamp cavities 108 may include tab slots 132 that may be configured to receive the clamp tabs 130. In one example, the tab slots 132 may be configured to align the clamp posts 118 in a defined position and orientation by only allowing the clamp posts 118 to be inserted into the clamp holes 108 when the clamp tabs 130 are aligned with the tab slots 132. As further discussed herein, once the clamp posts 118 are inserted into the clamp cavities 108, the clamp posts 118 may be locked into place to secure the modular attachment assembly 106 to the insert panel 102 until a user unlocks the modular attachment assembly 106 from the insert panel 102. In one example, once the clamp posts 118 are inserted into the clamp cavities 108, the clamp posts 118 may be rotated to secure the clamp tabs within a cavity of the clamp cavity 108. In one embodiment, a clamp post 108 may be 1.0 mm in height, 10 mm in diameter, and 10 mm in depth. In another embodiment, the clamp posts 118 may be 1.8 mm in height. The sizes, dimensions, and configurations provided herein are not intended to be limiting and may vary based on the size and/or shape of the container 100.

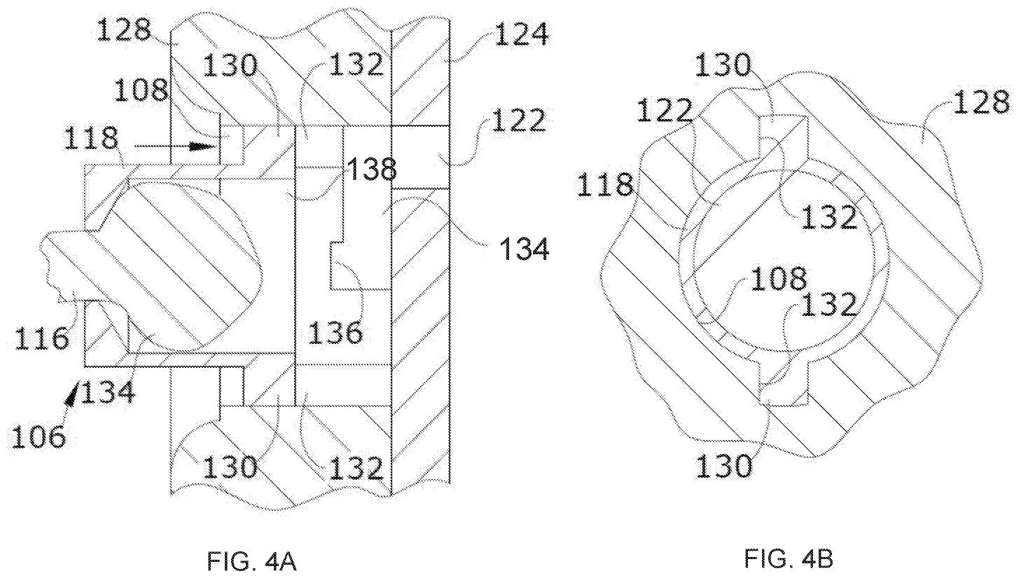

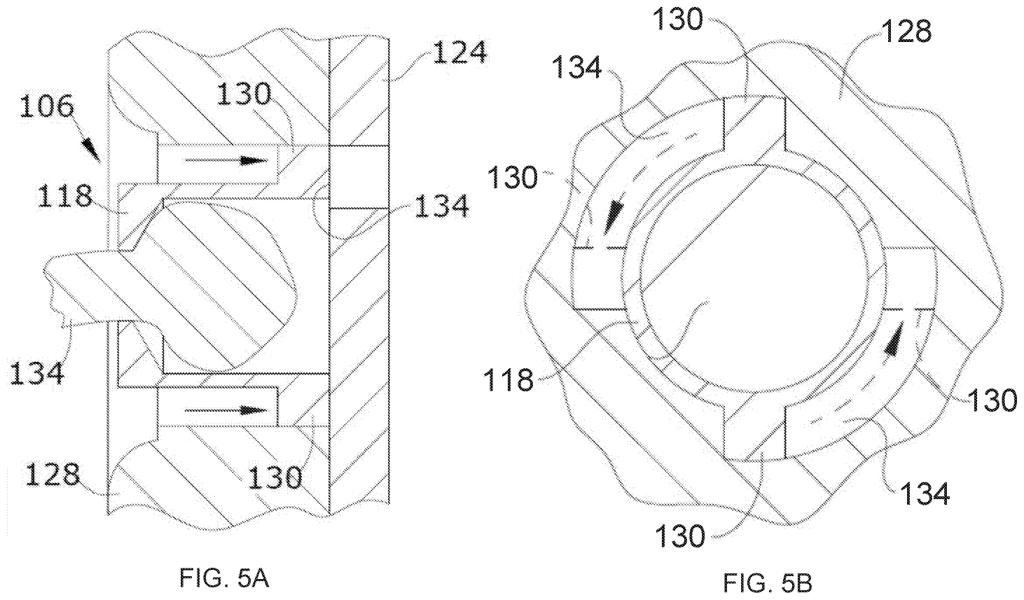

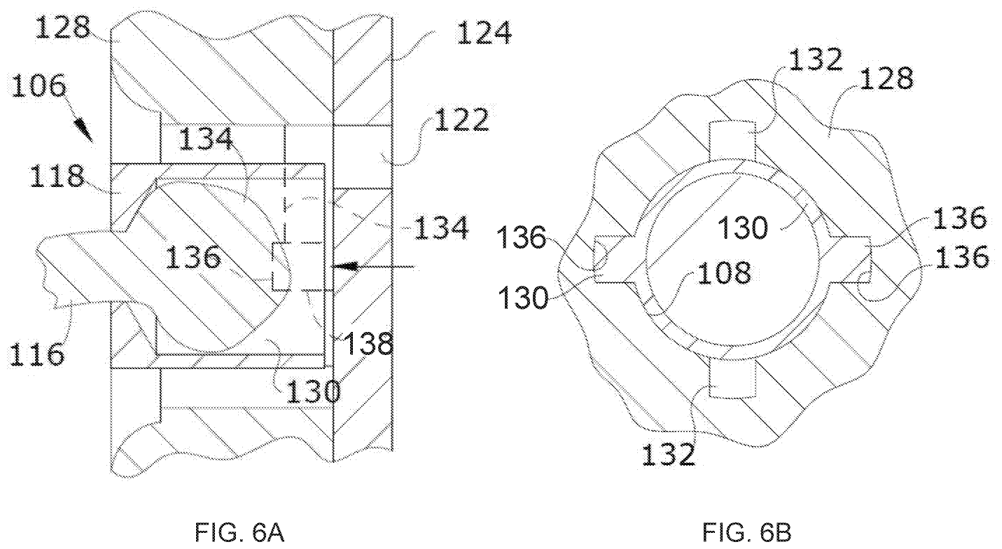

FIG. 4A illustrates a cross-sectional view of a portion of the modular attachment assembly 106 inserted into a clamp cavity 108, according to an embodiment. Some of the features in FIG. 4A are the same or similar to some of the features in FIGS. 1-3 as noted by same reference numbers, unless expressly described otherwise. As discussed above, the modular attachment assembly 106 may be attached to the insert panel 102 to fasten or hold an object against the insert panel 102. As further discussed above, the modular attachment assembly 106 may include the cord 116 and the clamp posts 118.

One of the clamp posts 118 may include a cavity 138 that may be configured to receive an end 135 of the cord 116. For example, the cavity 138 of the clamp post 118 may include an open portion that an end may be inserted and an opening 137 that the cord 116 may be threaded through such that the end 135 of the cord 116 may be held within the cavity 135. As discussed above, the clamp cavities 108 may include tab slots 132 that may be configured to receive the clamp tabs 130. In one example, the tab slots 132 may be configured to align the clamp posts 118 in a defined position and orientation by only allowing the clamp posts 118 to be inserted into the claim holes 108 when the clamp tabs 130 are aligned with the tab slots 132.

FIG. 4B illustrates a front view of the clamp cavity 108 with the clamp post 118 being inserted within, according to an embodiment. Some of the features in FIG. 4B are the same or similar to some of the features in FIGS. 1-4A as noted by same reference numbers, unless expressly described otherwise. As discussed above, the clamp cavity 108 may include tab slots 132 configured to receive the clamp tabs 130 as the clamp post 118 is inserted into the clamp cavity 108. As discussed above, when the clamp posts 118 are inserted into the clamp cavities 108, the clamp posts 118 may include clamp tabs 130 that may be rotated to lock and/or unlock the clamp posts 118 to the insert panel 102 via the tab slots 132.

FIG. 4C illustrates a cross-sectional view of a portion of the modular attachment assembly 106 inserted into a clamp cavity 108 and the clamp tabs 130 may be rotated to lock the clamp post 118 into place, according to an embodiment. Some of the features in FIG. 4C are the same or similar to some of the features in FIGS. 1-4B as noted by same reference numbers, unless expressly described otherwise. FIG. 4C illustrates a clamp post 118 that has been inserted into the clamp cavity 108 where the clamp post 118 is rotated to lock the clamp posts 118 to the insert panel 102 via the tab slots 132. The clamp post 118 may be rotated clockwise to lock the clamp post 118 and counterclockwise to unlock the clamp post 118, or vise versa. For example, the clamp post 118 may be configured to rotate a first direction within the clamp cavity 108 to lock the clamp post 118 within the clamp cavity 108 and rotate a second direction within the clamp cavity 108 to unlock the clamp post 118 within the clamp cavity 108.

FIG. 4D illustrates a front view of the clamp cavity 108 with the clamp post 118 being rotated to lock the clamp post 118 into place, according to an embodiment. Some of the features in FIG. 4D are the same or similar to some of the features in FIGS. 1-4C as noted by same reference numbers, unless expressly described otherwise. FIG. 4D illustrates a top view of the clamp post 118 that has been inserted into the clamp cavity 108, where the clamp post 118 is rotated to lock the clamp posts 118 to the insert panel 102 via the tab slots 132. In one embodiment, the clamp post 118 may be rotated clockwise to lock the clamp post 118 into place. In another embodiment, the clamp post 118 may be rotated counter-clockwise to unlock the clamp post 118 from the locked position to remove the clamp post from the clamp cavity 108.

FIG. 4E illustrates a cross-sectional view of the clamp tabs 130 of the clamp post 118 having been locked into place with the clamp cavity 108, according to an embodiment. Some of the features in FIG. 4E are the same or similar to some of the features in FIGS. 1-4D as noted by same reference numbers, unless expressly described otherwise. FIG. 4E illustrates the clamp post 118 that has locked to the insert panel 102 via the tab slots 132. As discussed above, the clamp post 118 may be rotated clockwise to lock the clamp post 118 and counterclockwise to unlock the clamp post 118, or vise versa. For example, the clamp tabs 130 may be inserted into the tab slots 132, wherein the tab slots 132 may be recessed to allow the clamp tabs 130 to lock into place when inserted and twisted into locking position.

FIG. 4F illustrates a front view of the clamp cavity 108 with the clamp post 118 having been locked into place, according to an embodiment. Some of the features in FIG. 4F are the same or similar to some of the features in FIGS. 1-4E as noted by same reference numbers, unless expressly described otherwise. FIG. 4F illustrates a top view of the clamp post 118 that has been locked to the insert panel 102 via the tab slots 132.

The sizes, dimensions, and configurations provided herein are not intended to be limiting and may vary based on the size and/or shape of the container 100.

The disclosure above encompasses multiple distinct embodiments with independent utility. While these embodiments have been disclosed in a particular form, the specific embodiments disclosed and illustrated above are not to be considered in a limiting sense as numerous variations are possible. The subject matter of the embodiments includes the novel and non-obvious combinations and sub-combinations of the various elements, features, functions and/or properties disclosed above and inherent to those skilled in the art pertaining to such embodiments. Where the disclosure or subsequently filed claims recite “a” element, “a first” element, or any such equivalent term, the disclosure or claims is to be understood to incorporate one or more such elements, neither requiring nor excluding two or more such elements.

Applicant(s) reserves the right to submit claims directed to combinations and sub-combinations of the disclosed embodiments that are believed to be novel and non-obvious. Embodiments embodied in other combinations and sub-combinations of features, functions, elements and/or properties may be claimed through amendment of those claims or presentation of new claims in the present application or in a related application. Such amended or new claims, whether they are directed to the same embodiment or a different embodiment and whether they are different, broader, narrower or equal in scope to the original claims, are to be considered within the subject matter of the embodiments described herein.

1. An apparatus, comprising:
a container configured to store an insert panel, the container including a slot configured to receive the insert panel;
the insert panel configured to hold an object, the insert panel comprising:
a front plate, comprising:
a first clamp cavity at a first location along a front surface of the front plate, wherein the first clamp cavity includes:
a first opening configured to receive a first clamp post of a modular attachment assembly;
a first tab slot configured to receive a first clamp tab of the first clamp post; and
a second tab slot configured to receive a second clamp tab of the first clamp post; and
a second clamp cavity at a second location along the front surface of the front plate, wherein the first clamp cavity includes:
a second opening configured to receive a second clamp post of the modular attachment assembly;
a third tab slot configured to receive a third clamp tab of the second clamp post; and
a fourth tab slot configured to receive a fourth clamp tab of the second clamp post; and
a back plate configured to fasten to a back surface of the front plate; and
the modular attachment assembly configured to hold the object against the insert panel, the modular attachment assembly comprising:
the first clamp post that includes:
the first clamp tab protruding at a first location of a side of the first clamp post; and
the second clamp tab protruding at a second location of the side of the first clamp post;
the second clamp post that includes:
the third clamp tab protruding at a first location of a side of the second clamp post; and
the fourth clamp tab protruding at a second location of the side of the second clamp post; and
an elastic cord having a first end connected to the first clamp post and a second end connected to the second clamp post, wherein the elastic cord is configured to:
expand to stretch over a surface of a portion of the object as the first clamp post is inserted into the first clamp cavity and the second clamp post is inserted into the second clamp cavity; and
contract to hold the object against the surface of the insert panel when the first clamp post is inserted into the first clamp cavity and the second clamp post is inserted into the second clamp cavity.

2. The apparatus of claim 1, wherein the container is a tool chest configured to store a tool.

3. The apparatus of claim 2, wherein the object is the tool.

4. The apparatus of claim 1, herein the elastic cord is a nylon-cased rubber band.

5. The apparatus of claim 1, wherein:
the first clamp post is configured to:
rotate a first direction within the first clamp cavity to lock the first clamp post within the first clamp cavity; and
rotate a second direction within the first clamp cavity unlock the first clamp post within the first clamp cavity; and
the second clamp post is configured to:
rotate the first direction within the second clamp cavity to lock the second clamp post within the second clamp cavity; and
rotate the second direction within the second clamp cavity to unlock the second clamp post within the second clamp cavity.

6. The apparatus of claim 1, wherein:
the first clamp post includes a first cavity configured to receive the first end of the elastic cord; and
the second clamp post includes a second cavity configured to receive the second end of the elastic cord.

7. The apparatus of claim 1, wherein the front plate further comprises a third clamp cavity at a third location along the front surface of the front plate, wherein the third clamp cavity includes:
a fifth opening configured to receive the first clamp post of the modular attachment assembly;
a fifth tab slot configured to receive the first clamp tab of the first clamp post; and
a sixth tab slot configured to receive the second clamp tab of the first clamp post.

8. The apparatus of claim 7; wherein the front plate further comprises a fourth clamp cavity at fourth location along the front surface of the front plate, wherein the fourth clamp cavity includes:
a sixth opening configured to receive the second clamp post of the modular attachment assembly;
a seventh tab slot configured to receive the second clamp tab of the second clamp post; and
an eighth tab slot configured to receive the second clamp tab of the second clamp post.

9. The apparatus of claim 8; wherein:
the first clamp post is configured to be inserted into the first clamp hole or the third hole based on a size or a shape of the object; and
the second clamp post is configured to be inserted into the second clamp hole or the fourth hole based on the size or the shape of the object.

10. The apparatus of claim 1, wherein the back plate further comprises a drain hole configured to provide a drain for a fluid or other material to exit the first clamp cavity or the second clamp cavity.

11. An apparatus, comprising:
a first insert panel configured to hold an object, the first insert panel comprising:
a first clamp cavity at a first location along a front surface of the first insert panel, wherein the first clamp cavity includes a first opening configured to receive a first clamp post of a modular attachment assembly; and
a second clamp cavity at a second location along the front surface of the first insert panel, wherein the first clamp cavity includes a second opening configured to receive a second clamp post of the modular attachment assembly;
the modular attachment assembly configured to hold the object against the first insert panel, the modular attachment assembly comprising:
the first clamp post;
the second clamp post; and
an elastic cord having a first end connected to the first clamp post and a second end connected to the second clamp post.

12. The apparatus of claim 11, wherein the object is a tool, a device, a utensil, a supply, or a piece of equipment.

13. The apparatus of claim 11, further comprising a container configured to store the first insert panel.

14. The apparatus of claim 13, wherein the container includes a slot configured to receive the first insert panel.

15. The apparatus of claim 11, further comprising a second insert panel configured to hold the object, the second insert panel comprising:
a third clamp cavity at a first location along a front surface of the second insert panel, wherein the third clamp cavity includes a first opening configured to receive the first clamp post of the modular attachment assembly; and
a fourth clamp cavity at a second location along the front surface of the second insert panel, wherein the fourth clamp cavity includes a second opening configured to receive the second clamp post of the modular attachment assembly.

16. The apparatus of claim 11, wherein the first insert panel further comprises a front plate and a back plate configured to fasten to a back surface of the front plate.

17. The apparatus of claim 11, wherein:
the first clamp cavity comprises:
a first tab slot configured to receive a first clamp tab of the first clamp post; and
a second tab slot configured to receive a second clamp tab of the first clamp post;
the second clamp cavity comprises:
a third tab slot configured to receive a third clamp tab of the second clamp post; and
a fourth tab slot configured to receive a fourth clamp tab of the second clamp post;
the first clamp post comprises:
the first clamp tab protruding at a first location of a side of the first clamp post; and
the second clamp tab protruding at a second location of the side of the first clamp post; and
the second clamp post comprises:
the third clamp tab protruding at a first location of a side of the second clamp post; and
the fourth clamp tab protruding at a second location of the side of the second clamp post.

18. The apparatus of claim 11, wherein the elastic cord is configured to:
expand to stretch over a surface of a portion of the object as the first clamp post is inserted into the first clamp cavity and the second clamp post is inserted into the second clamp cavity; and
contract to hold the object against a surface of the first insert panel when the first clamp post is inserted into the first clamp cavity and the second clamp post is inserted into the second clamp cavity.

19. An apparatus, comprising:
an insert panel configured to hold an object, the insert panel comprising:
a first clamp cavity including a first opening configured to receive a first clamp post of a modular attachment assembly; and
a second clamp cavity including a second opening configured to receive a second clamp post of the modular attachment assembly; and
the modular attachment assembly configured to hold the object against the insert panel, the modular attachment assembly comprising:
the first clamp post;
a second clamp post; and
a cord having a first end connected to the first clamp post and a second end connected to the second clamp post.

20. The apparatus of claim 19, further comprising a container configured to store the insert panel.
